(19) United States
(12) Patent Application Publication
(10) Pub. No.: US 2012/0275346 A1
(43) Pub. Date: Nov. 1, 2012

(54) NETWORK DEVICE AND POWER SAVING METHOD

(75) Inventor: CHENG-HSIN WANG, Tu-Cheng (TW)

(73) Assignee: HON HAI PRECISION INDUSTRY CO., LTD., Tu-Cheng (TW)

(21) Appl. No.: 13/437,939

(22) Filed: Apr. 3, 2012

(30) Foreign Application Priority Data
Apr. 29, 2011 (CN) 201110110611.8

(51) Int. Cl. H04L 12/28

(52) U.S. Cl. 370/256

(57) ABSTRACT

A network device transmits broadcasting packets to other network devices in a local area network (LAN) after the network device is connected to the LAN, and receives response packets from the other network devices. The network devices determines whether the network device is a root bridge according to the response packets, and computes power consumption between the network device and each of the other network devices when the network device is the root bridge. The network device selects a path with the lowest power consumption from the network device to each of the other network devices, and builds a new spanning tree according to the selected path.

### BACKGROUND

1. Technical Field

The present disclosure relates to network communications, and more particularly to a network device and a power saving method for the network device.

2. Description of Related Art

Power-saving for environmental protection is a theme in the world today. The design of network products is more likely to pay attention to power-saving. However, the power-saving design is limited to a single network device. It becomes a big challenge to achieve power-saving in a local area network (LAN).

### BRIEF DESCRIPTION OF THE DRAWINGS

The details of the disclosure, both as to its structure and operation, can be best understood by referring to the accompanying drawing, in which like reference numbers and designations refer to like elements.

FIG. 1 is a schematic diagram of an application environment of one embodiment of a network device in accordance with the present disclosure.

FIG. 2 is a schematic diagram of functional modules of one embodiment of the network device in accordance with the present disclosure.

FIG. 3 is a schematic diagram showing a rebuilding module building a new spanning tree in accordance with one embodiment of the present disclosure.

FIG. 4 is a schematic diagram showing the rebuilding module building another spanning tree in accordance with another embodiment of the present disclosure.

FIG. 5 is a flowchart of one embodiment of a power saving method of a network device in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

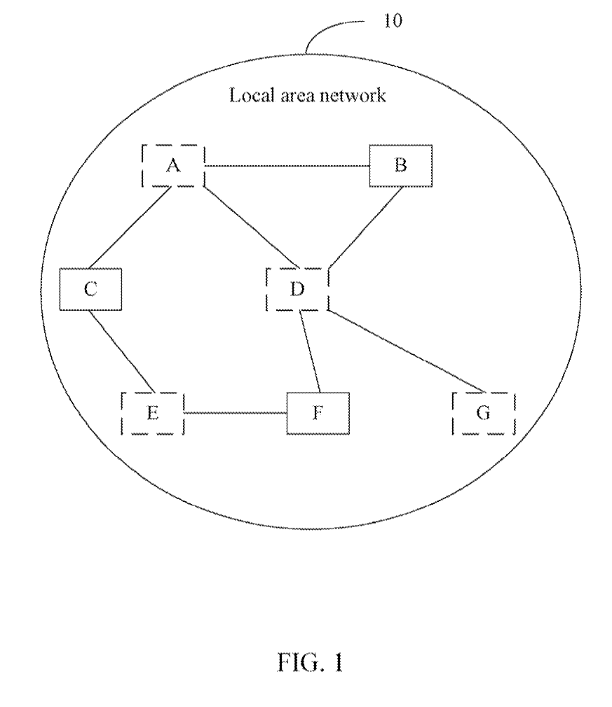

FIG. 1 is a schematic diagram of an application environment of one embodiment of a network device A in accordance with the present disclosure. In one embodiment, a local area network (LAN) 10 includes the network device A and other network devices B, C, D, E, F, and G. The network devices A, B, C, D, E, F, and G wirelessly communicate with each other in the LAN 10, or communicate with each other via a wired connection. In one embodiment, the network devices may be gateways, switches, or routers, for example.

In one embodiment, some network devices, such as B, C, F are marked by full lines while other network devices, such as A, D, E, G are marked by broken lines. The network devices marked by broken lines, such as the network devices A, D, E, G support an energy efficient ethernet (EEE) function. The network devices marked by full lines such as the network devices B, C, F do not support the EEE function. The EEE function, as one of ordinary skill would appreciate, is technology found on new PHY chips that can monitor link traffic and drop connections into a low power state when no data is flowing, a condition that exists more than 90% of the time.

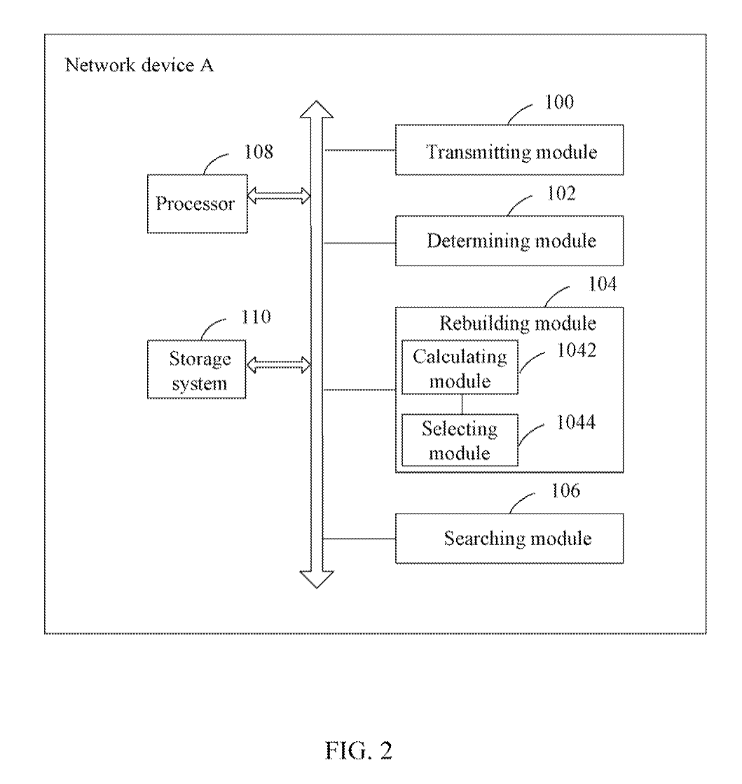

FIG. 2 is a schematic diagram of functional modules of one embodiment of the network device A in accordance with the present disclosure. In one embodiment, functional modules of the network devices B, C, D, E, F, and G in the LAN 10 are the same as those of the network device A, so only the functional modules of the network device A are described hereinafter for example.

The network device A includes a transmitting module 100, a determining module 102, a rebuilding module 104, a searching module 106, at least one processor 108, and a storage system 110. The rebuilding module 104 includes a calculating module 1042 and a selecting module 1044. The modules 100-106 may include computerized code in the form of one or more programs that are stored in the storage system 110. The computerized code includes instructions that are executed by the at least one processor 108 to provide functions for the modules 100-106. In one example, the storage system 110 may include a hard disk drive, a flash memory, a cache or another computerized memory device.

The transmitting module 100 transmits broadcasting packets to the other network devices B, C, D, E, F, and G in the LAN 10 to notify that the network device A is connected to the LAN 10 after the network device A is connected to the LAN 10. The broadcasting packets includes a bridge identifier of the network device A and other information such as whether the network device A supports the EEE function.

In one embodiment, the bridge identifier that is expressed as 64 bits binary includes a priority address and a media access control (MAC) address. The priority address is expressed as 16 bits binary. The MAC address is expressed as 48 bits binary. Generally, the LAN 10 assigns the priority address to each network device in the LAN 10. The bridge identifier is usually written as hexadecimal for convenience. For example, if the bridge identifier of one network device is 24-6C-90-FB-A6-33-64-98 in the LAN 10, the priority address is 24-6C, and the MAC address is 90-FB-A6-33-64-98.

In one embodiment, each network device in the LAN 10 supports a spanning tree protocol (STP). A working mode of the STP is to span a tree of the STP. A root of the tree is called a root bridge. A leaf of the tree is called a node, and a route from the root to one node or from one node to another node is called a transmission path. The LAN 10 assigns a priority address to each network device in the LAN 10. The lower the priority address the network device is assigned, the more likely the network device becomes the root bridge. When there are two network devices with the same priority address in the LAN 10, the MAC addresses of the two network devices are compared. In fact, an original spanning tree has been spanned according to the STP in the LAN 10 before the network device A is connected to the LAN 10, and is operable to transmit broadcasting packets in order to avoid a broadcast storm of broadcasting packets. Thus, it avoids looping of the LAN 10 that leads to broadcasting packets being circularly transmitted and makes the LAN 10 exhaust its resources.

In general, the spanning tree includes a network device as the root bridge and the other network devices, and the broadcasting packets are forwarded from one network device to the other devices in the spanning tree via the transmission path of the spanning tree. For example, if the network device A is the boot bridge, there are three transmission paths: A-C-E, A-D-F-E, and A-B-D-F-E in the LAN 10 as shown in FIG. 1. The network device A can select one transmission path from the tree transmission paths in the LAN 10, and then transmits the broadcasting packets from the network device A to the network device E via the selected transmission path. Similarly, the network device A transmits all follow-up packets to the network device E via the selected transmission path. A new spanning tree needs to be built only when a topology in the LAN 10 has been changed such as that a new network device connected to the LAN 10.

In one embodiment, the transmitting module 100 transmits broadcasting packets to the other network devices B, C, D, E, F, G, and receives response packets from the other network devices B, C, D, E, F, G in the LAN 10, where each of the broadcasting packets includes the bridge identifier of the network device, and each of the response packets includes the bridge identifier of each of the other network devices.

The determining module 102 determines whether the bridge identifier of the network device A is lower than the bridge identifier of each of the other network devices B, C, D, E, F, G in the LAN 10 according to the response packets. In one embodiment, each of the response packets includes the bridge identifier of each of the other network devices, therefore, the determining module 102 compares the bridge identifiers that is expressed as 64 bits binary of each of the other network devices in the LAN 10. For example, the bridge identifier of the network device A is 24-6C-90-FB-A6-33-64-98, the priority address is 24-6C, the MAC address is 90-FB-A6-33-64-98 in the LAN 10. The bridge identifier of the network device B is 24-6D-90-FB-A6-33-64-97, the priority address is 24-6D, and the MAC address is 90-FB-A6-33-64-97 in the LAN 10. the determining module 102 comparing the bridge identifiers of the network device A and B is first comparing the 24-6C that the priority address of the bridge identifier of the network device A and 24-6D that the priority address of the bridge identifier of the network device B. 24-6C is lower than 24-6D, then the bridge identifier of the network device A is lower than the bridge identifier of the network device B, the network device A should be a root bridge.

The rebuilding module 104 determines that the network device A is the root bridge when the bridge identifier of the network device A is lower than the bridge identifier of each of the other network devices B, C, D, E, F, and G. In one embodiment, the new spanning tree needs to be built when the new network device A is the boot bridge in the LAN 10 based on the STP.

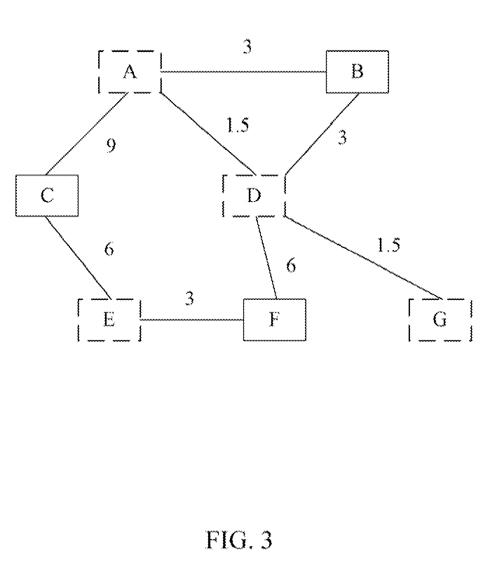

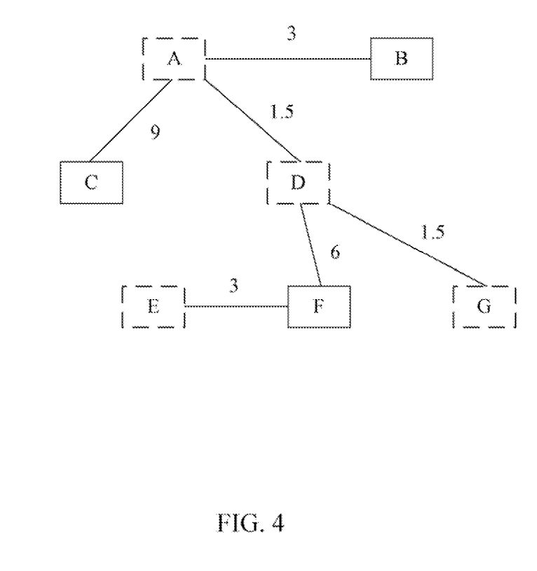

In one embodiment, the detailed practices of building a new spanning tree as shown in FIG. 3 and FIG. 4.

FIG. 3 is a schematic diagram showing a rebuilding module building a new spanning tree in accordance with one embodiment of the present disclosure. FIG. 4 is a schematic diagram showing the rebuilding module building another spanning tree in accordance with another embodiment of the present disclosure.

In one embodiment, the rebuilding module 104 includes a calculating module 1042 and a selecting module 1044. The calculating module 1042 computes power consumption between the network device A and each of the other network devices after the network device A is connected to the LAN 10. In one embodiment, the network device A links neighbor network devices though different types of ports like RJ-45 port, BNC port, AUI port, or a Fiber port, for example. Each of the ports transmits packets by different rate: 10 Mbps, 100 Mbps, 1 Gbps, and 10 Gbps, for example. Power consumption between the two network devices equals a rate of transmission of packets between the two network devices multiplied by a default percentage value. If both two network devices support the EEE function, the default percentage value is 50%. If only one of the two network devices supports the EEE function, the default percentage value is 100%.

The network devices A and B, A and C, A and D are neighboring as shown in FIG. 3. A rate of transmission of packets between the network devices A and B, A and C, A and D is 100 Mbps, 10 Gbps, 100 Mbps, the network devices A and D marked by broken lines support the EEE function. The network devices B and C marked by full lines do not support the EEE function, then power consumption between the network devices A and B, A and C, A and D is 100×100%=100, 10000×100%=10000, 100×50%=50. In one embodiment, it provides 100 Mbps=3, 1 Gbps=6, 10 Gbps=9, for convenient calculation. Thus, power consumption between the network device A and B, A and C, A and D is simplified into 3, 9, 1.5. In other embodiments, power consumption between the two network devices is simplified into the other value. In one embodiment, by way of analogy, compute of power consumption between the other network devices B, C, D, E, F, G and its neighboring network devices, at the last, forms the diagram of the spanning tree as shown in FIG. 3.

The selecting module 1044 selects a path with the lowest power consumption from the network device A to each of the other network devices, and builds the new spanning tree according to the selected path. For example, there are three paths with A-B, A-D-B, A-C-E-F-D-B from the network device A to the network device B, wherein power consumption of the paths A-B, A-D-B, A-C-E-F-D-B is 3, 1.5+3=4.5, 9+6+3+6+3=27, as shown in FIG. 3. Power consumption of the path A-B is the lowest among the three paths, so the LAN 10 selects the path A-B, and by way of analogy, selects path from the network device A to each of the other network devices, at the last, forms the diagram of the new spanning tree as shown in FIG. 4. There is only one path from the network device A to each of the other network devices in the LAN 10, and power consumption of the path is the lowest. The network device A transmits all follow-up packets to each of the other network devices according to the built the new spanning tree as shown in FIG. 4. In this way, it can greatly reduces power consumption.

Referring to FIG. 2, the searching module 106 determines that the network device A is not the root bridge when the bridge identifier of the network device A is not lower than the bridge identifier of each of the other network devices in the LAN 10. There is an original boot bridge in the LAN 10 before the network device A is connected to the LAN 10, so the searching module 106 computes power consumption between the network device A and each of the other network devices, selects a path with the lowest power consumption from the original root bridge to each of the other network devices, cuts off links of the other paths except the selected path, and updates an original spanning tree in the LAN 10. In one embodiment, the method of the searching module 106, computing power consumption and selecting the path is the same as the method of the selecting module 1044, computing power consumption and selecting the path.

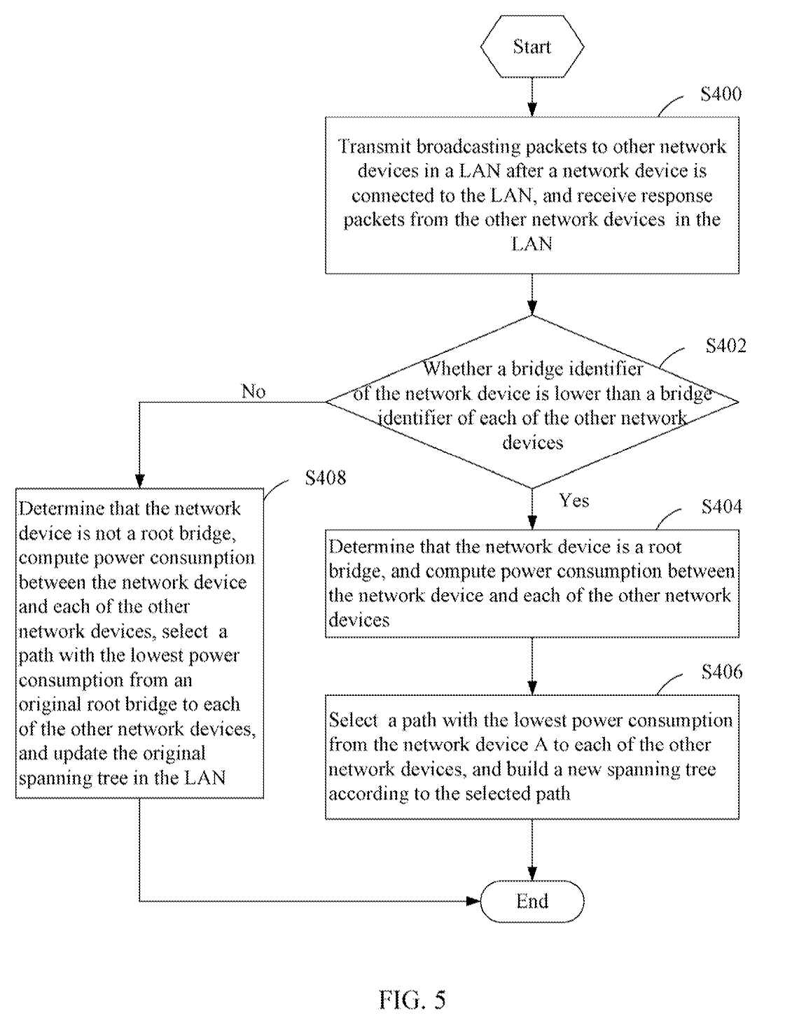

FIG. 5 is a flowchart of one embodiment of a power saving method of a network device A in accordance with the present disclosure. The method may be embodied in the network device A, and is executed by the functional modules such as those of FIG. 2.

In block S400, the transmitting module 100 transmits broadcasting packets to the other network devices B, C, D, E, F, G in a local area network (LAN) 10 to notify that a new network device A is connected to the LAN 10 after the network device A is connected to the LAN 10, and receives response packets from the other network devices B, C, D, E, F, G in the LAN 10. The broadcasting packets includes a media access control (MAC) address of the network device A and other information such as whether the network device A supports the EEE function.

In one embodiment, each network device in the LAN 10 supports a spanning tree protocol (STP). A working mode of the STP is to span a tree. A root of the tree is called a root bridge. A leaf of the tree is called a node, and a route from the root to one node or from one node to another node is called a transmission path. The LAN 10 assigns a priority address to each network device in the LAN 10. The lower priority address the network device is assigned, the more likely the network device becomes the root bridge. When there are two network devices with the same priority address in the LAN 10, the MAC addresses of the two network devices are compared. In fact, an original spanning tree has been spanned according to the STP in the LAN 10 before the network device A is connected to the LAN 10, and is operable to transmit broadcasting packets in order to avoid a broadcast storm of broadcasting packets. Thus, it avoids looping of the LAN 10 that leads to broadcasting packets being circularly transmitted and makes the LAN 10 exhaust its resources.

In general, the spanning tree includes a network device as the root bridge and the other network devices, the broadcasting packets was forwarded from one network device to the other devices in the spanning tree via the transmission path of the spanning tree. For example, if the network device A is the boot bridge, there are three transmission paths: A-C-E, A-D-F-E, and A-B-D-F-E in the LAN 10 as shown in FIG. 1. The network device A can select one transmission path from the tree transmission paths in the LAN 10, and then transmits the broadcasting packets from the network device A to the network device E via the selected transmission path. Similarly, the network device A transmits all follow-up packets to the network device E via the selected transmission path. A new spanning tree needs to be built only when a topology in the LAN 10 has been changed such as that a new network device connected to the LAN 10.

In block S402, the determining module 102 determines whether the bridge identifier of the network device A is lower than the bridge identifier of each of the other network devices B, C, D, E, F, G in the LAN 10 according to the response packets.

In one embodiment, each of the response packets includes the bridge identifier of each of the other network devices, therefore, the determining module 102 compares the bridge identifiers that is expressed as 64 bits binary of each of the other network devices in the LAN 10.

In block S404, the rebuilding module 104 determines that the network device A is the root bridge when the bridge identifier of the network device A is lower than the bridge identifier of each of the other network devices B, C, D, E, F, G, and the calculating module 1042 computes power consumption between the network device A and each of the other network devices after the network device A is connected to the LAN 10. In one embodiment, the new spanning tree needs to be built when the new network device A is the boot bridge in the LAN 10 based on the STP. The new spanning tree is built by the calculating module 1042 and the selecting module 1044.

In one embodiment, the network device A links neighbor network devices though different types of ports like RJ-45 port, BNC port, AUI port, Fiber port, for example. Each of the ports transmits packets by different rate: 10 Mbps, 100 Mbps, 1 Gbps, or 10 Gbps, for example. Power consumption between the two network devices equals a rate of transmission of packets between the two network devices multiply by a default percentage value. If both two network devices support the EEE function, the default percentage value is 50%. If only one of the two network devices supports the EEE function, the default percentage value is 100%. The network devices A and B, A and C, A and D are neighboring as shown in FIG. 3. A rate of transmission of packets between the network devices A and B, A and C, A and D is 100 Mbps, 10 Gbps, 100 Mbps, the network devices A and D marked by broken lines support the EEE function. The network devices B and C marked by full lines do not support the EEE function, then power consumption between the network devices A and B, A and C, A and D is 100×100%=100, 10000×100%=10000, 100×50%=50. In one embodiment, it provides 100 Mbps=3, 1 Gbps=6, 10Gbps=9, for convenient calculation. Thus, power consumption between the network device A and B, A and C, A and D is simplified into 3, 9, 1.5. In other embodiment, power consumption between the two network devices is simplified into the other value. In one embodiment, by way of analogy, compute of power consumption between the other network devices B, C, D, E, F, G and its neighbor network devices, at the last, forms the diagram of the spanning tree as shown in FIG. 3.

In block S406, the selecting module 1044 selects a path with the lowest power consumption from the network device A to each of the other network devices, and builds the new spanning tree according to the selected path. For example, there are three paths with A-B, A-D-B, A-C-E-F-D-B from the network device A to the network device B, where power consumption of the paths A-B, A-D-B, A-C-E-F-D-B is 3, 1.5+3=4.5, 9+6+3+6+3=27, as shown in FIG. 3. Power consumption of the path A-B is the lowest among the three paths, so the LAN 10 selects the path A-B, and by way of analogy, selects path from the network device A to each of the other network devices, at the last, forms the diagram of the new spanning tree as shown in FIG. 4. There is only one path from the network device A to each of the other network devices in the LAN 10, and power consumption of the path is the lowest. The network device A transmits all follow-up packets to each of the other network devices according to the building new spanning tree as shown in FIG. 4. In this way, it can greatly reduce power consumption to the point of power saving.

In block S408, the searching module 106 determines that the network device A is not the root bridge when the bridge identifier of the network device A is not lower than the bridge identifier of each of the other network devices B, C, D, E, F, and G in the LAN 10. There is an original boot bridge in the LAN 10 before the network device A is connected to the LAN 10, so the searching module 106 computes power consumption between the network device A and each of the other network devices, selects a path with the lowest power consumption from the original root bridge to each of the other network devices, cuts off the link with the other paths, and updates the original spanning tree in the LAN 10. In one embodiment, the method of the searching module 106, computing power consumption and selecting the path is the same as the method of the selecting module 1044 computing power consumption and selecting the path.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A network device in a local area network (LAN) with other network devices in the LAN, the network device comprising:
at least one processor;
a storage system;
one or more programs that are stored in the storage system and are executed by the at least one processor, the one or more programs comprising:
a transmitting module operable to transmit broadcasting packets to the other network devices in the LAN, and receive response packets from the other network devices, wherein each of the broadcasting packets comprises a bridge identifier of the network device, and each of the response packets comprises a bridge identifier of each of the other network devices;
a determining module operable to determine whether the bridge identifier of the network device is lower than the bridge identifier of each of the other network devices according to the response packets; and
a rebuilding module operable to determine that the network device is a root bridge when the bridge identifier of the network device is lower than the bridge identifier of each of the other network devices, compute power consumption between the network device and each of the other network devices, select a path with the lowest power consumption from the network device to each of the other network devices, and build a new spanning tree according to the selected path.

2. The network device as described in claim 1, wherein the bridge identifier of the network device comprises a priority address and a media access control (MAC) address of the network device, and the bridge identifier of each of the other network devices comprises a priority address and a MAC address of each of the other network devices.

3. The network device as described in claim 1, further comprising a searching module operable to determine that the network device is not the root bridge when the bridge identifier of the network device is not lower than the bridge identifier of each of the other network devices.

4. The network device as described in claim 3, wherein the searching module is further operable to compute power consumption between the network device and each of the other network devices when the network device is not the root bridge, select a path with the lowest power consumption from an original root bridge to each of the other network devices, cut off links of the other paths except the selected path, and update an original spanning tree in the LAN.

5. A power saving method of a network device in a local area network (LAN) including other network devices in the LAN, the power saving method comprising:
transmitting broadcasting packets to the other network devices in the LAN after the network device is connected to the LAN, and receive response packets from the other network devices, wherein each of the broadcasting packets comprises a bridge identifier of the network device, and each of the response packets comprises a bridge identifier of each of the other network devices;
determining whether the bridge identifier of the network device is lower than the bridge identifier of each of the other network devices according to the response packets;
determining that the network device is a root bridge when the bridge identifier of the network device is lower than the bridge identifier of each of the other network devices;
computing power consumption between the network device and each of the other network devices;
selecting a path with the lowest power consumption from the network device to each of the other network devices; and
building a new spanning tree according to the selected path.

6. The power saving method as described in claim 5, wherein the bridge identifier of the network device comprises a priority address and a media access control (MAC) address of the network device, and the bridge identifier of each of the other network devices comprises a priority address and a MAC address of each of the other network devices.

7. The power saving method as described in claim 5, further comprising steps of:
determining that the network device is not the root bridge when the bridge identifier of the network device is not lower than the bridge identifier of each of the other network devices.

8. The power saving method as described in claim 7, further comprising steps of:
computing power consumption between the network device and each of the other network devices when the network device is not the root bridge;
selecting a path with the lowest power consumption from an original root bridge to each of the other network devices, and cutting off links of the other paths except the selected path; and
updating an original spanning tree in the LAN.
